(19) United States
(12) Patent Application Publication
(10) Pub. No.: US 2005/0071056 A1
(43) Pub. Date: Mar. 31, 2005

(54) Control arrangement for a propulsion unit for a self-propelled floor care appliance

(76) Inventors: Aaron P. Tondra, North Canton, OH (US); Evan A. Gordon, Canton, OH (US)

Correspondence Address: A. Burgess Lowe, 101 East Maple Street, North Canton, OH, 44720, US

(21) Appl. No.: 10/677,999

(22) Filed: Sep. 30, 2003

(51) Int. Cl. G01C 22/00

(52) U.S. Cl. 701/23

(57) ABSTRACT

A self propelled upright vacuum cleaner is provided with a hall effect sensor to provide a varying voltage according to the position of the cleaner handle. The varying voltage is input to a microprocessor which controls the speed and direction of the propulsion motor. The microprocessor is programmed with one or more desirable response characteristics for the propulsion motor based upon the input from the hall effect sensor. In an alternate embodiment of the invention, two hall effect sensors are utilized to provide a pair of voltages to a microprocessor to control the speed and direction of the motor. In another alternate embodiment, a wheel sensor is used to detect the movement of the suction nozzle and provide an output to the microprocessor to control the speed and direction of the propulsion drive motor.

### FIELD OF THE INVENTION

Generally, the invention relates to controls. Particularly, the invention relates to a programmable control arrangement for propulsion unit for a self-propelled floor care appliance such as a vacuum cleaner.

### BACKGROUND OF THE INVENTION

It is known to produce a self-propelled upright vacuum cleaner by providing a transmission in the foot or lower portion of the cleaner for selectively driving at least one drive wheel in forward rotation and reverse rotation for selectively propelling the cleaner forward and backward over a floor. A handgrip is commonly mounted to top of the upper housing in a sliding fashion for limited reciprocal motion relative to the upper housing as an operator pushes and pulls on the handgrip. A Bowden type control cable typically extends from the hand grip to the transmission for transferring the pushing and pulling forces applied to the hand grip by an operator to the transmission and thereby selectively actuating a forward drive clutch and a reverse drive clutch of the transmission.

However, such arrangements provide little or no flexibility in providing for controlling the speed of the propulsion drive motor. The present invention provides a hall effect sensor and a magnet arrangement in the cleaner handle which provides an output based upon the movement of the handle. The output from the hall effect sensor is input to a microprocessor which is programmed to output a signal to control the speed and direction of the propulsion drive motor based upon the output of the hall effect sensor. Therefore, the present invention fulfills a need not heretofore addressed in the prior art.

### SUMMARY OF THE INVENTION

In carrying out the invention in one aspect thereof, these objectives and advantages are obtained by providing a machine including a floor care appliance such as vacuum cleaner having a control arrangement for the propulsion unit. In the preferred embodiment of the present invention, a hall effect sensor and a magnet provide an output based upon the movement of the cleaner handle. The output from the hall effect sensor is input to a control circuit having a microprocessor which is programmed to output a signal to control the speed and direction of the transmission based output from the hall effect sensor. The microprocessor can be programmed such that the transmission has “response characteristics” that follow a mathematical expression or values from a data table based upon the movement of the handle by the user. With the use of programmable response characteristics more than one set of response characteristics can be programmed into the microprocessor. Through the use of a switch or other means a user can choose which response characteristics are suitable for their own personal preference when manipulating the handgrip to propel the cleaner.

### BRIEF DESCRIPTION OF DRAWINGS

Embodiments of the invention, illustrative of several modes in which applicants have contemplated applying the principles are set forth by way of example in the following description and are shown in the drawings and are particularly and distinctly pointed out and set forth in the appended claims.

FIG. 1 is a perspective view of a vacuum cleaner which includes the present invention;

FIG. 2 is the vacuum cleaner of FIG. 1 with a partial cutaway portion of the housing with the handle in the in use position;

FIG. 3 is a cutaway portion of the upper handle with a partial cutaway portion of the handgrip showing the hall effect sensor and magnet;

FIG. 4 is an electrical schematic of the control circuit having a programmable microprocessor for controlling a propulsion arrangement having a variable and user selectable response characteristic;

FIG. 5A is a graphical display of the voltage generated by the hall effect sensor that is input to the microprocessor as a function of time, according to the preferred embodiment of the present invention;

FIG. 5B is a graphical display of the voltage applied to the propulsion motor as a function of time based upon the input to the microprocessor from the hall effect sensor as shown in FIG. 5A, according to the preferred embodiment of the present invention;

FIG. 5C is a graphical display of the voltage applied to the propulsion motor as a function of time based upon the input to the microprocessor from the hall effect sensor as shown in FIG. 5A, according to an alternate embodiment of the present invention; and

FIG. 5D is a graphical display of the voltage applied to the propulsion motor as a function of time based upon the input to the microprocessor from the hall effect sensor as shown in FIG. 5A, according to another alternate embodiment of the present invention.

### DESCRIPTION OF THE PREFERRED EMBODIMENT

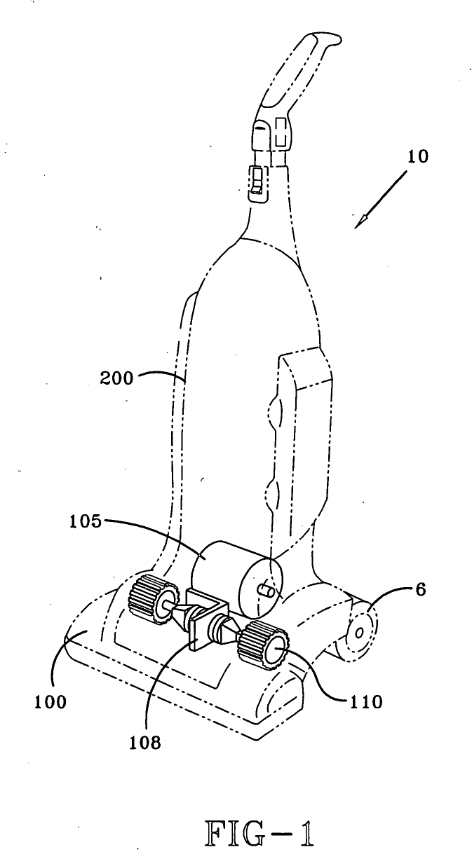

A self-propelled upright vacuum cleaner 10 according to a preferred embodiment of the present invention is diagrammatically illustrated by way of example in FIG. 1. The cleaner includes a foot or lower engaging portion 100. The vacuum cleaner 100 is of the type having an agitator (not shown) and positioned within an agitator chamber (not shown) formed in an agitator housing which is part of foot 100. The agitator chamber (not shown) communicates with the nozzle opening (not shown) and the agitator (not shown) rotates about a horizontal axis inside the agitator chamber (not shown) for loosening dirt from the floor surface. The loosened dirt is drawn into a suction duct located behind and fluidly connected to agitator chamber (not shown) by a suction airstream generated by a motor-fan assembly (not shown). The suction duct (not shown) directs the loosened dirt to a dirt particle filtration and collecting system positioned in a handle or upper housing 200. Freely rotating support wheels 106 (only one of which is visible in FIG. 1) are located to the rear of the foot 100. The foot 100 further includes a transmission 108 and drive wheels 110 for propelling the cleaner 10 in forward and reverse over a floor. A rotary power source such as electric motor 105 provides rotary power to the transmission 108. The details of the transmission 108 do not form a part of the present invention and are therefore not disclosed in detail herein. However, a suitable transmission for use with a self-propelled upright vacuum cleaner according to the present invention is disclosed in U.S. Pat. No. 3,581,591, the disclosure of which is hereby incorporated by reference herein.

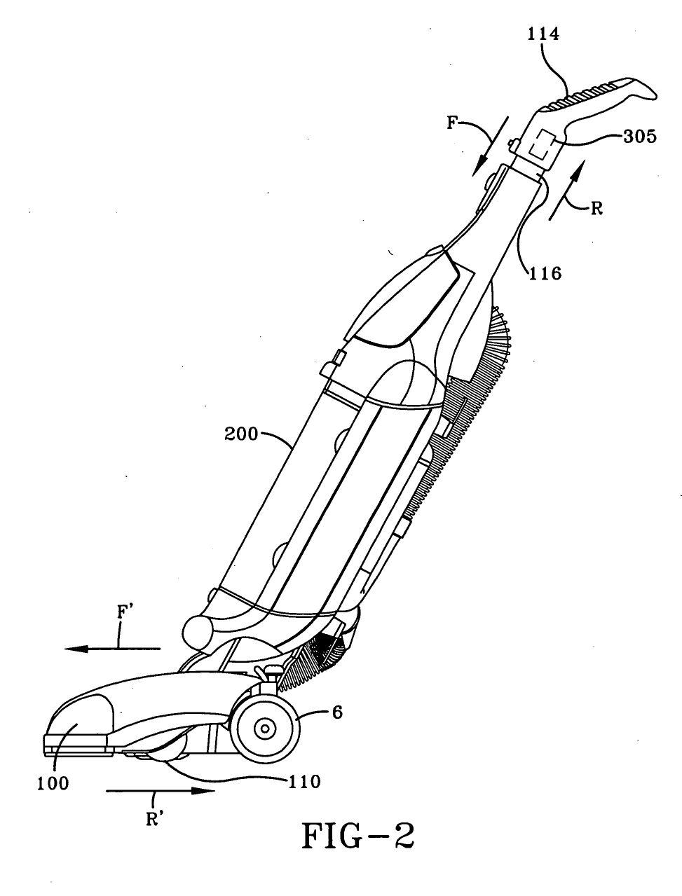

Referring now to FIG. 2, the handle or upper housing portion 200 is pivotally mounted to the foot 100 in a conventional manner for pivotal motion from a generally upright latched storage position, illustrated in FIG. 1, to an inclined pivotal operating position, as shown in FIG. 2. In the preferred embodiment of the invention, the vacuum cleaner 10 is similar to the indirect air bagless vacuum cleaner disclosed in Hoover Case 2649, U.S. patent application Ser. No. 10/417,866 owned by a common assignee and incorporated by reference fully herein. In an alternate embodiment of the invention, the vacuum cleaner may be a direct air vacuum cleaner or any other type of floor care appliance.

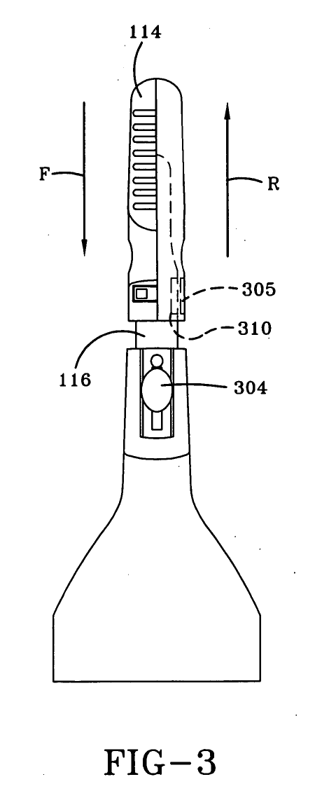

In the preferred embodiment of the invention, a hand grip 114 is slidably mounted to a handle stem 116 that is attached to the upper end of the upper housing portion 200 for limited reciprocal rectilinear motion relative to the handle stem 114 as illustrated by arrows F and R. The hand grip 114 controls the speed and direction of transmission 108 via an electronic switching arrangement. In the preferred embodiment of the present invention, the electronic switching arrangement is an analog linear hall effect sensor 310 located in proximity to a magnet 305 (shown best in FIG. 3). The hall effect sensor 310 generates a voltage the magnitude of which corresponds to the position of the sensor hall effect 310 in relation to the magnet 305. This information is input to a microprocessor 450 to control the speed and direction of the transmission motor 108. Movement of the handgrip 114 in the direction of arrow F causes an input to the microprocessor 450 to cause the cleaner 10 to be propelled in the direction of arrow F′. The speed by which the transmission 108 causes the cleaner 100 to be propelled is dependent on the movement of handgrip 114 in the direction of arrow F. The resultant speed as a function of the movement of handgrip 114 is pre-programmed into microprocessor 450.

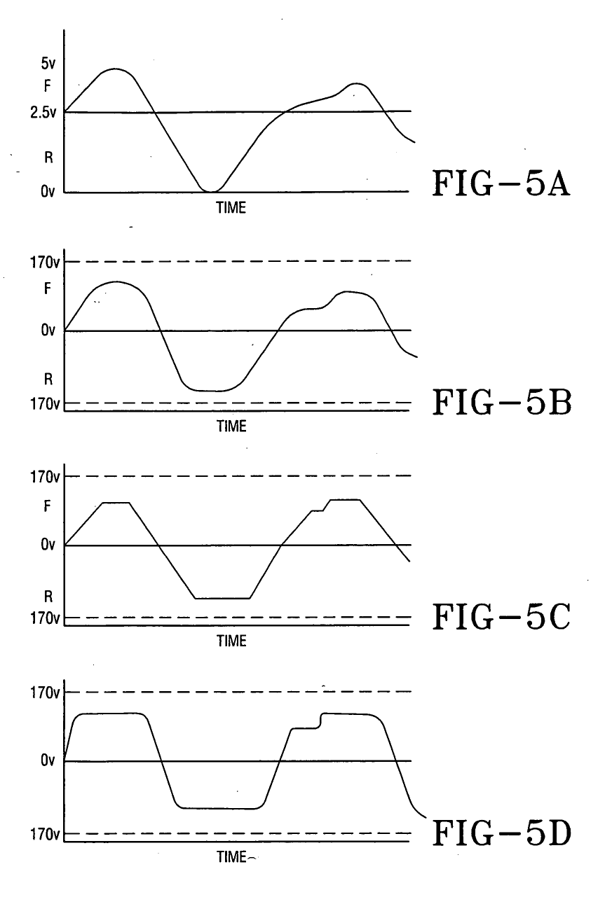

In this manner, many different response characteristics of the transmission 108 to the movement of handgrip 114 and the resultant input to microprocessor 450 can be programmed into microprocessor 450. A switch (not shown) could be provided to allow a user to select one of several possible response characteristics pre-programmed into the microprocessor 450. Alternately, response characteristics can be programmed into the microprocessor 450 via a connection (not shown) to a computer (not shown) or computer network (not shown). A user can then select which response characteristics are desirable for them and download them to microprocessor 450. These pre-programmed “response characteristics” are described more fully hereinbelow. Generally, these response characteristics can be described by a mathematical expression and graphically illustrated as seen in FIGS. 5B-5D (described more fully hereinbelow). Similarly, the microprocessor 450 can be programmed with response characteristics for the transmission 108 when handgrip 114 is moved in the direction of arrow R to propel the cleaner 100 in the direction of arrow R′.

Referring now to FIG. 3, shown is a cutaway portion of the upper end of upper housing portion 200 with a portion of handgrip 114 further cutaway. A permanent magnet 305 is mounted on the interior sidewall of handgrip 114 and position in proximity to hall effect sensor 310. Hall effect sensor 310 mounted on the handle stem 116 such that magnet 305 moves relative to hall effect sensor 310 when handgrip 114 is translated in the direction of arrows F and R. Hall effect sensor 310 is connected to microprocessor 450 by wiring (not shown). A power switch button 304 is preferably located adjacent to a top of the handle stem 116 near the hand grip 114 for convenient actuation of an electric power switch (not shown) for turning the cleaner 100 on and off. The electric power switch (not shown) controls the power supplied to a control circuit 400 and to microprocessor 450 being connected thereto by wiring (also not shown).

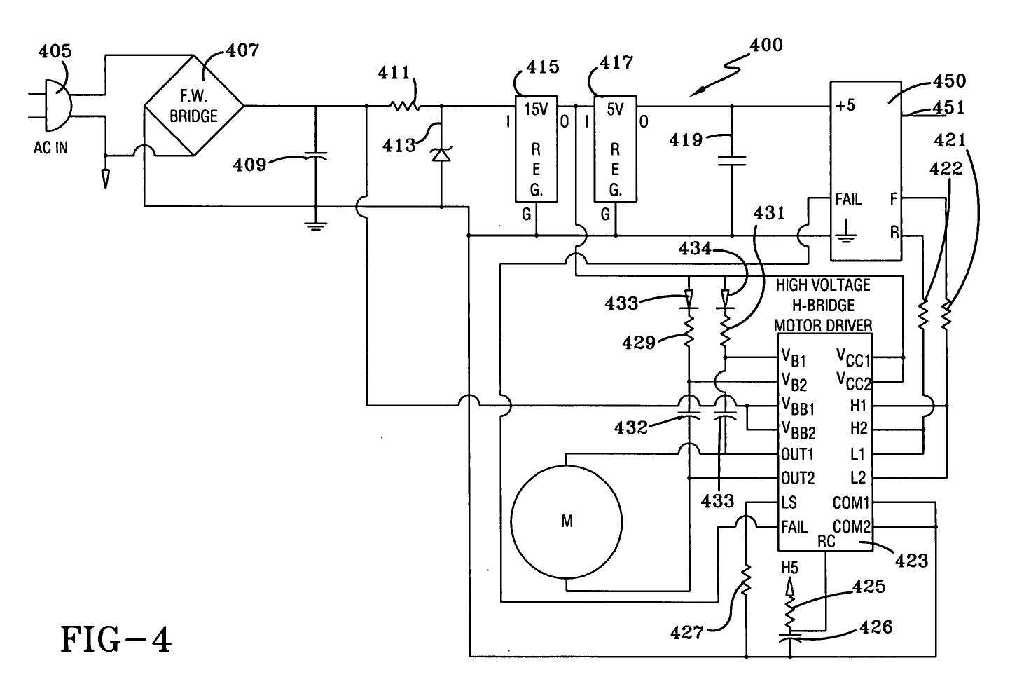

Referring now to FIG. 4, an electrical schematic of the control circuit 400 for providing and controlling the power supplied to transmission motor 105 is shown. A 120 vac power source 405 is connected to a full Wheatstone bridge 407 to convert the alternating current to a 170 volt direct current. A 220 microfarad smoothing capacitor 409 smooths the direct current. A 2.2 K ohm resistor 411 and a 33 volt Zener diode 413 clamp the voltage to 33 volts which is input to a voltage regulator 415 which outputs a regulated 15 volts for supplying power to an H-Bridge Motor Driver 423. The H-Bridge Motor Driver 423 is of a well known type using field effect transistors (FET's) to control the current supplied to motor M. The fifteen volts is also inputted into a 5 volt voltage regulator which outputs a regulated 5 volts for supplying power to microprocessor 450. The output voltages from hall effect sensor 310 are input at pin 451 to microprocessor 450 which determines the magnitude and polarity of the voltages. The microprocessor 450 provides a pre-programmed output to L1, L2, H1 and H2 on H-Bridge Motor Driver 423. When a voltage is applied to H1 and L2, the motor M will rotate in the forward direction. Oppositely, when a voltage is applied to L1 and H2, the motor M will rotate in the reverse direction. In this manner, using pulse width modulation on L1, L2, H1 and H2, the microprocessor 450 can control the speed of the motor M in both directions based upon the effort that the user places on the handle in the forward and reverse direction. If the user lightly pushes or pulls on the handle, the motor M can run slowly in the forward and reverse direction. Likewise, if the user heavily pushes or pulls on the handle, the motor M can run at a much greater speed in the forward and reverse direction. Based upon the effort placed upon the handle, the linear hall sensor 310 yields a different analog voltage, which in turn yields a different motor M speed. A charge pump circuit charges the external capacitors 432, 433 between the output pins OUT1 and OUT2 and the VB1 and VB2 pins. The capacitors 432, 433 provide enough voltage to the high side driver circuit to drive the high side MOSFET. The charging process is occurring when the output voltage us low. A pair of resistors 429, 431 and a pair of diodes 433, 434 form a current limiting circuit to limit the current flowing to VB1 and VB2. A resistor 427 connected to the low side output pin LS is used as a current sense to determine if a motor stall has occurred or not. If a stall has occurred, then the motor is shutdown. An RC circuit comprised of a resistor 425 and a capacitor 426 has the ability to shut itself down if the current through the system reaches a fixed level. The varying current in the system charges and discharges the RC network and when it hits a predetermined level based upon component selection the part shuts down. A pair of current limiting resistors 421, 422 limit the current between the forward F and reverse R outputs on microprocessor 450 and the inputs L1 and L2 on H-Bridge 423. In the preferred embodiment of the invention, the values of the various components are as follows: capacitor 409=220 micro farad; resistor 411=2.2 K ohm; diode 413=33 volt zener diode; capacitor 419=0.1 micro farad; diodes 433, 434=200 volt, 1 amp; resistors 429, 431=30 ohm; capacitors 432, 433=4.7 micro farad; resistors 421, 422=10 K ohm; resistor 427=0.25 ohm; resistor 425=1 M ohm; and capacitor 426=220 micro farad.

Referring now to FIGS. 5A-5D, and for the moment FIG. 5A, shown is a graphical depiction of the voltage input to the microprocessor 450 from the hall effects sensor 310 as a the handle is moved from the neutral position to the maximum forward speed position and the maximum reverse speed position. In the neutral position, the hall effect sensor 310 normally inputs 2.5 volts into the microprocessor 450. As the handle is moved from the neutral position to the maximum forward position, the voltage input into the microprocessor 450 will vary in a linear fashion from the 2.5 volts to a maximum of 5 volts in the maximum forward speed position. Oppositely, as the handle is moved from the neutral position to the maximum reverse position the voltage input into the 450 decreases in a linear fashion from the 2.5 volts to 0 volts in the maximum reverse speed position. The microprocessor 450 has a pre-programmed response to the voltage input from the hall effect sensor 310 that is input to the H-Bridge Motor Driver 423 using pulse width modulation on L1, L2, H1 and H2.

In the preferred embodiment of the invention, as seen in FIG. 5B, the pre-programmed response of the motor M is created by microprocessor 450 by pulse width modulation. As the voltage input into microprocessor 450 rises to maximum of 5 volts as the handle is moved linearly in the forward direction toward the desired operating speed, the voltage applied to motor M rises proportionally and begins to smooth off as the maximum voltage of 170 volts is applied. As the handle is pulled back in the direction of the neutral position, the voltage from the hall effect sensor 310 input into the microprocessor 450 begins to drop and drops back to a low of 2.5 volts when the handle has fully returned into the neutral position. As the handle is further pulled into the reverse direction position, the voltage drops from the 2.5 volts to a low of 0 volts when the handle is in the maximum reverse speed position. Microprocessor 450 pulse width modulates the voltage applied to motor M so that the voltage will first begin to drop in a smooth manner and then proportionally to position of the handle as the handle is pulled from the forward speed position towards the neutral position.

Similarly, the microprocessor 450 pulse width modulates the voltage applied to motor M so that the voltage increases proportionally during the travel of the handle in the reverse direction R and begins to smooth off as the maximum voltage of 170 volts is applied. If the handle is moved from the neutral position in a linear fashion, the response of the motor M will be linear for the majority of the travel of the handle except as the handle approaches the maximum forward and reverse operating speeds as seen in FIG. 5B. If the handle is not moved from the neutral position in a linear fashion, as demonstrated by the portion of the line graph to the right in FIG. 5A, the response of the motor M will not be linear as it approaches operating speed as demonstrated by the portion of the line graph to the right in FIG. 5B.

In an alternate embodiment of the programming of the microprocessor 450, and referring now to FIG. 5C, the microprocessor 450 can be programmed to pulse width modulate the voltage applied to motor M so that the voltage increases linearly to operating speed as the handle is moved in the forward F or reverse R directions and once the handle is in the fully forward or reverse positions, the voltage is then capped at a peak voltage and will stay at that voltage until the handle is released at which time the voltage will drop in a linear fashion until it reaches zero. If the handle is not moved in a linear fashion in the forward F and reverse R directions (as demonstrated by the right portion of FIG. 5C) the microprocessor 450 still pulse width modulates the voltage applied to motor M so that the voltage increases linearly to the operating speed and will remain constant until the handle is moved again in either direction.

In yet another alternate embodiment of the programming of microprocessor 450, and referring now to FIG. 5D, as the handle is moved linearly in the forward F or reverse R directions the microprocessor 450 can be programmed to pulse width modulate the voltage applied to motor M so that the voltage increases linearly at a higher rate towards operating speed but is smoothed slightly just before operating speed. Once operating speed is reached, the voltage remains constant until the handle is released at which time the voltage will begin to drop smoothly at first but then in a likewise linear fashion until it reaches zero. If the handle is not moved in a linear fashion in the forward and reverse directions (as demonstrated by the right portion of FIG. 5D) the microprocessor 450 still pulse width modulates the voltage applied to motor M so that the voltage increases at the same aforesaid linear rate but is smoothed just before the operating speed is reached. The voltage will remain constant until the handle is moved again in either direction at which point the voltage will either smoothly increase or decrease before increasing or decreasing at the aforesaid linear rate. Although specific examples of the response of the motor M have been disclosed, there are many other possible responses that are possible by programming the microprocessor 450.

In another embodiment of the invention, two hall effect sensors with a single magnet could be utilized as a trigger arrangement with two voltages be inputted into microprocessor 450 for controlling the motor voltage and direction. Alternately, instead of a moving handgrip, a wheel sensor could be utilized to detect the movement of the cleaner suction nozzle when the pushes or pulls on the cleaner handle. The wheel sensor could sense the speed anmddetect both the amount of force transmitted to the suction nozzle via the handle and produce a representative voltage which is input to the microprocessor 450. The microprocessor 450 uses pulse width modulation on L1, L2, H1 and H2 to control direction and speed of motor M. Of course microprocessor 450 can be programmed to provide any desired output for motor M such as the output shown in FIGS. 5B-5C.

Accordingly, the control arrangement for a propulsion drive unit for a floor care appliance is simplified, provides an effective, inexpensive, and efficient arrangement which achieves all of the enumerated objectives. While there has been shown and described herein a single embodiment of the present invention, it should be readily apparent to persons skilled in the art that numerous modifications may be made therein without departing from the true spirit and scope of the invention. Accordingly, it is intended by the appended claims to cover all modifications which come within the spirit and scope of the invention.

1. A programmable control arrangement for a self-propelled floor care appliance, comprising:
a self-propelled floor care appliance having a propulsion drive motor for propelling the floor care appliance over a surface to be cleaned;
a hall effect sensor positioned in an operative relationship with a handle located on the distal end of an upper housing of said floor care appliance to sense the desired direction and speed of the floor care appliance from the user and provide a corresponding output;
a programmable microprocessor to receive the output from the device for outputting a signal according to pre-programmed logic; and
a controller for receiving the signal and providing a voltage to a propulsion drive motor at a corresponding voltage and polarity.

2. The programmable control arrangement for a self-propelled floor care appliance of claim 1, wherein said hall effect sensor outputs a voltage of varying magnitude based upon the position of the hall effect sensor relative to a magnet embedded in the floor care appliance handle.

3. The programmable control arrangement for a self-propelled floor care appliance of claim 2, wherein said floor care appliance handle is pushed and pulled by the user to cause the magnet embedded in said handle to move relative to said hall effect sensor to cause to said propulsion motor to propel said floor care appliance in the forward and reverse directions.

4. The programmable control arrangement for a self-propelled floor care appliance of claim 1, wherein said programmable microprocessor is pre-programmed to pulse width modulate the voltage applied to the propulsion drive motor based upon the position of said handle such that the response of the propulsion drive motor is follows a pre-determined characteristic.

5. The programmable control arrangement for a self-propelled floor care appliance of claim 4, wherein said pre-determined characteristic is a based upon a mathematical algorithm.

6. The programmable control arrangement for a self-propelled floor care appliance of claim 5, wherein said pre-determined characteristic is a based upon a table of values.

7. A programmable control arrangement for a self-propelled floor care appliance, comprising:
a handle at the distal end of the upper portion of the floor care appliance capable of translating from a neutral position to a forward and reverse position by a user applying a pushing or pulling movement of a varying magnitude amount on the handle;
a propulsion drive motor for propelling said floor care appliance over a surface to be cleaned;
a magnet located adjacent to the handle;
a hall effect sensor mounted in the handle and positioned in an operative relationship with the magnet, said hall effect sensor generating a voltage of varying magnitude according to the relative position of the hall effect sensor to the magnet as the handle is moved from the neutral position to the forward and reverse positions;
a programmable microprocessor for receiving the varying voltage from said hall effect sensor for outputting a signal according to pre-programmed logic based upon the magnitude of said voltage; and
an H-bridge controller for controlling the flow of current and voltage applied to said propulsion drive motor based upon said signal from said microprocessor.

8. The programmable control arrangement for a self-propelled floor care appliance of claim 7, wherein said programmable microprocessor is pre-programmed to pulse width modulate the voltage applied to the propulsion drive motor by said H-bridge based upon the movement of said handle such that the response of the propulsion drive motor is based upon a mathematical algorithm.

9. The programmable control arrangement for a self-propelled floor care appliance of claim 10, wherein said programmable microprocessor is pre-programmed to pulse width modulate the voltage applied to the propulsion drive motor by said H-bridge based upon the movement of said handle such that the response of the propulsion drive motor is a based upon a table of values.

10. A programmable control arrangement for a self-propelled floor care appliance, comprising:
a self-propelled floor care appliance having a propulsion drive motor for propelling the floor care appliance over a surface to be cleaned;
a hall effect sensor positioned in an operative relationship with a wheel located on a main body of said floor care appliance to sense the desired direction and speed of the floor care appliance and provide a corresponding output;
a programmable microprocessor to receive the output from the hall effect sensor for outputting a signal according to pre-programmed logic; and
a controller for receiving the signal and providing a voltage to a propulsion drive motor at a corresponding voltage and polarity.

11. The programmable control arrangement for a self-propelled floor care appliance of claim 10, wherein said hall effect sensor outputs a voltage of varying value based upon the rotation of a series of magnets positioned circumferentially on said wheel past said hall effect sensor.

12. The programmable control arrangement for a self-propelled floor care appliance of claim 10 wherein said wheel is rotated when a user either pushes or pulls on a handle located on the distal end of said floor care appliance.

13. The programmable control arrangement for a self-propelled floor care appliance of claim 11, wherein said programmable microprocessor is pre-programmed to pulse width modulate the voltage applied to the propulsion drive motor based upon the speed said magnets are rotated past said hall effect sensor such that the response of the propulsion drive motor follows a pre-determined characteristic.

14. The programmable control arrangement for a self-propelled floor care appliance of claim 13, wherein said pre-determined characteristic is a based upon a mathematical expression.

15. The programmable control arrangement for a self-propelled floor care appliance of claim 13, wherein said pre-determined characteristic is a based upon a table of values.
